(19) United States
(12) Patent Application Publication
(10) Pub. No.: US 2025/0365643 A1
(43) Pub. Date: Nov. 27, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/292,282

(22) Filed: Aug. 6, 2025

Related U.S. Application Data
(63) Continuation of application No. PCT/JP2024/004180, filed on Feb. 7, 2024.

(51) Int. Cl. H04W 48/02; H04W 8/22; H04W 88/04; H04W 88/08

(52) U.S. Cl. CPC H04W 48/02; H04W 8/22; H04W 88/04; H04W 88/08

(57) ABSTRACT

In an aspect, a communication control method is a communication control method used in a cellular communication system. The communication control method includes, at a parent node, broadcasting mobile relay node support information indicating that a mobile relay node that is movable is supported, and legacy relay node support information indicating both that the mobile relay node is supported and that a legacy relay node that is not movable is supported.

### RELATED APPLICATIONS

The present application is a continuation based on PCT Application No. PCT/JP2024/004180, filed on Feb. 7, 2024, which claims the benefit of U.S. Provisional Patent Application No. 63/444,309 filed on Feb. 9, 2023. The content of which is incorporated by reference herein in their entirety.

### TECHNICAL FIELD

The present disclosure relates to a communication control method used in a cellular communication system.

### BACKGROUND

The Third Generation Partnership Project (3GPP), which is a standardization project of a cellular communication system, has studied the introduction of a new relay node referred to as an Integrated Access and Backhaul (IAB) node (e.g., see Non-Patent Document 1). One or more relay nodes are involved in communication between a base station and a user equipment and perform relay for the communication.

### CITATION LIST

### Non-Patent Literature

Non-Patent Document 1: 3GPP TS 38.300 V17.3.0 (2022-12)

### SUMMARY

In a first aspect, a communication control method is a communication control method used in a cellular communication system. The communication control method includes, at a parent node, when broadcasting mobile relay node support information, broadcasting legacy relay node support information, the mobile relay node support information indicating that a mobile relay node that is movable is supported, and the legacy relay node support information indicating that access of the mobile relay node is granted and a legacy relay node that is not movable is supported.

In a second aspect, a communication control method is a communication control method used in a cellular communication system. The communication control method includes, at a mobile relay node, determining whether access to a parent node having broadcast mobile relay node support information and/or legacy relay node support information is possible, based on whether the mobile relation node receives the mobile relay node support information indicating that the mobile relay node that is movable is supported, and the legacy relay node support information indicating that access of the mobile relay node is granted and a legacy relay node that is not movable is supported.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, Parent nodes, and Child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to RRC connection and NAS connection of an IAB-MT.

FIG. 7 is a diagram illustrating an example of a protocol stack relating to an F1-U protocol.

FIG. 8 is a diagram illustrating an example of a protocol stack relating to an F1-C protocol.

FIG. 9 is a diagram illustrating whether access restriction of an IAB node is performed according to the first embodiment.

FIG. 10 is a flowchart illustrating a first operation example according to the first embodiment.

FIG. 11 is a flowchart illustrating a second operation example according to the first embodiment.

FIG. 12 is a flowchart illustrating a third operation example according to the first embodiment.

FIG. 13 is a flowchart illustrating a first operation example according to the second embodiment.

FIG. 14 is a flowchart illustrating a second operation example according to the second embodiment.

FIG. 15 is a diagram illustrating scenarios and subcases of cell reselection of a UE.

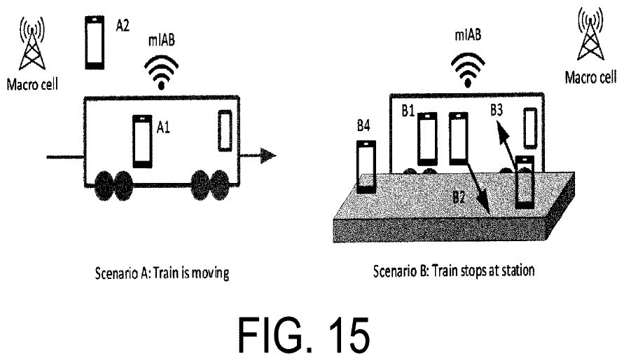

FIG. 16 is a diagram illustrating RACH-less handover according to LTE.

### DESCRIPTION OF EMBODIMENTS

A cellular communication system according to an embodiment will be described with reference to the drawings. In the description of the drawings, the same or similar parts are denoted by the same or similar reference signs.

### First Embodiment

### Configuration of Cellular Communication System

A configuration example of the cellular communication system according to an embodiment will be described. A cellular communication system 1 according to the embodiment is a 3GPP 5G system. Specifically, a radio access scheme in the cellular communication system 1 is a New Radio (NR) being a 5G radio access scheme. Note that Long Term Evolution (LTE) may be at least partially applied to the cellular communication system 1. A future cellular communication system such as 6G may be also applied to the cellular communication system 1.

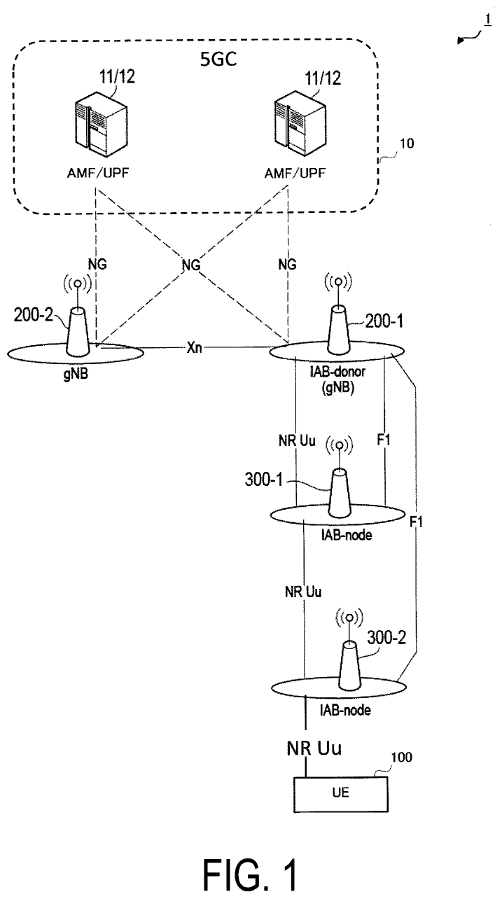

FIG. 1 is a diagram illustrating a configuration example of the cellular communication system 1 according to the embodiment.

As illustrated in FIG. 1, the cellular communication system 1 includes a 5G core network (5GC) 10, a User Equipment (UE) 100, base station apparatuses (hereinafter may be referred to as “base stations”) 200-1 and 200-2, and IAB nodes 300-1 and 300-2. A base station 200 may be referred to as a gNB.

In the following, an example in which the base station 200 is an NR base station will be mainly described, but the base station 200 may also be an LTE base station (that is, an eNB).

In the following, the base stations 200-1 and 200-2 may be referred to as the gNBs 200 (or base station 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is an apparatus that performs various mobility controls for the UE 100. The AMF 11 communicates with the UE 100 using Non-Access Stratum (NAS) signaling to manage information on an area in which the UE 100 exists. The UPF 12 is an apparatus that performs transfer control of user data, and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, a cell and a base station may be used without distinction.

Each gNB 200 is interconnected with the 5GC 10 via an interface referred to as an NG interface. FIG. 1 illustrates the two gNB 200-1 and gNB 200-2, connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU, and includes an F1-C protocol, which is a control plane protocol, and an F1-U protocol, which is a user plane protocol.

The cellular communication system 1 supports IAB, which enables radio relay of NR access using an NR for backhaul. The donor gNB 200-1 (or a donor node; hereinafter may be referred to as a “donor node”) is a terminal node of the NR backhaul on the network side, and is a donor base station having additional functions for supporting IAB. The backhaul is capable of multi-hopping via a plurality of hops (that is, a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted by two backhaul hops.

The UE 100 is a wireless communication apparatus that is movable and performs wireless communication with a cell. The UE 100 may be any apparatus that performs wireless communication with the gNB 200 or the IAB node 300. For example, the UE 100 is a mobile phone terminal and/or a tablet terminal, a laptop PC, a sensor or an apparatus provided in a sensor, a vehicle or an apparatus provided in a vehicle, or an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

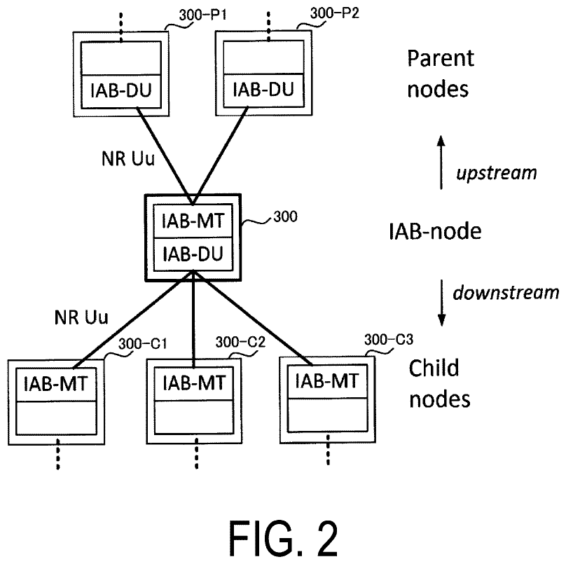

FIG. 2 is a diagram illustrating an example of a relationship between the IAB node 300, Parent nodes, and Child nodes.

As illustrated in FIG. 2, each IAB node 300 includes an IAB-DU equivalent to a base station function unit and an IAB-MT (Mobile Termination) equivalent to a user equipment function unit.

Adjacent nodes (that is, upper nodes) on an NR Uu radio interface of the IAB-MT are referred to as parent nodes. The parent node is a DU of a parent IAB node or the donor node 200. A radio link between the IAB-MT and the parent node is referred to as a backhaul link (BH link). FIG. 2 illustrates an example in which the parent nodes of the IAB node 300 are IAB nodes 300-P1 and 300-P2. A direction toward the parent nodes is referred to as upstream. From the perspective of the UE 100, the upper node of the UE 100 may correspond to a parent node. Adjacent nodes (that is, lower nodes) on the NR access interface of the IAB-DU are referred to as child nodes. The IAB-DU manages the cell similarly to the gNB 200. The IABDU terminates the NR Uu radio interface to the UE 100 and the lower IAB nodes. The IAB-DU supports the F1 protocol to the CU of the donor node 200-1. FIG. 2 illustrates an example in which the child nodes of the IAB node 300 are IAB nodes 300-C1 to 300-C3, but the child node of the IAB node 300 may also include the UE 100. A direction toward the child nodes is referred to as downstream.

All of the IAB nodes 300 connected to the donor node 200 via one or more hops form a Directed Acyclic Graph (DAG) topology (hereinafter may be referred to as “topology”) with the donor node 200 as the root. In this topology, as illustrated in FIG. 2, adjacent nodes on the IAB-DU interface are child nodes, and adjacent nodes on the IAB-MT interface are parent nodes. The donor node 200 performs central management including resource, topology, and route management of the IAB topology. The donor node 200 is a gNB that provides network access to the UE 100 via a network of backhaul links and access links.

### Configuration of Base Station

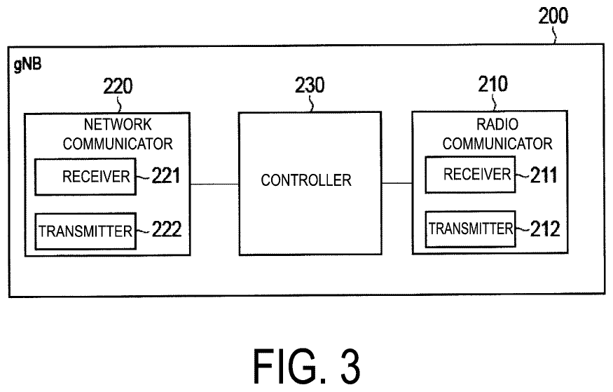

The configuration of the gNB 200, which is a base station according to the embodiment, will be described. FIG. 3 is a diagram illustrating a configuration example of the gNB 200. As illustrated in FIG. 3, the gNB 200 includes a radio communicator 210, a network communicator 220, and a controller 230.

The radio communicator 210 performs wireless communication with the UE 100 and wireless communication with the IAB node 300. The radio communicator 210 includes a receiver 211 and a transmitter 212. The receiver 211 performs various types of reception under the control of the controller 230. The receiver 211 includes an antenna, and converts (down-converts) a radio signal received by the antenna into a baseband signal (reception signal) and outputs the signal to the controller 230. The transmitter 212 performs various types of transmission under the control of the controller 230. The transmitter 212 includes an antenna, and converts (up-converts) a baseband signal (transmission signal) output by the controller 230 into a radio signal and transmits the signal from the antenna.

The network communicator 220 performs wired communication (or wireless communication) with the 5GC 10 and wired communication (or wireless communication) with the other adjacent gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 230 may perform all of the processing and operations in the gNB 200 in each embodiment to be described below.

### Configuration of Relay Node

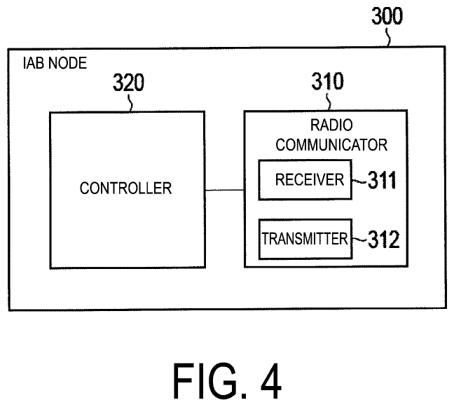

A configuration of the IAB node 300 that is a relay node (or a relay node apparatus, which may hereinafter be referred to as a “relay node”) according to the embodiment will be described. FIG. 4 is a diagram illustrating a configuration example of the IAB node 300. As illustrated in FIG. 4, the IAB node 300 includes a radio communicator 310 and a controller 320. The IAB node 300 may include a plurality of the radio communicators 310.

The radio communicator 310 performs wireless communication (BH link) with the gNB 200 and wireless communication (access link) with the UE 100. The radio communicator 310 for BH link communication and the radio communicator 310 for access link communication may be provided separately.

The radio communicator 310 includes a receiver 311 and a transmitter 312. The receiver 311 performs various types of reception under the control of the controller 320. The receiver 311 includes an antenna, and converts (down-converts) a radio signal received by the antenna into a baseband signal (reception signal) and outputs the converted signal to the controller 320. The transmitter 312 performs various types of transmission under the control of the controller 320. The transmitter 312 includes an antenna, and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 320 may perform each process or each operation in the IAB node 300 in each embodiment to be described below.

### Configuration of User Equipment

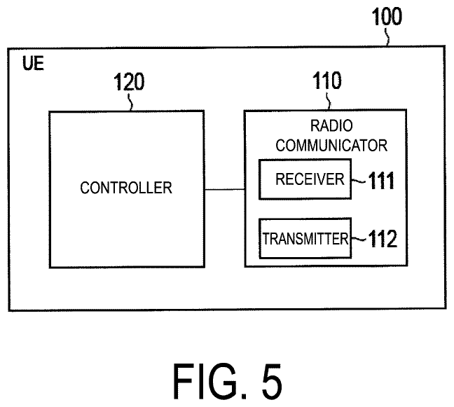

The configuration of the UE 100, which is a user equipment according to the embodiment, will be described. FIG. 5 is a diagram illustrating a configuration example of the UE 100. As illustrated in FIG. 5, the UE 100 includes a radio communicator 110 and a controller 120.

The radio communicator 110 performs wireless communication in an access link, that is, wireless communication with the gNB 200 and wireless communication with the IAB node 300. The radio communicator 110 may also perform wireless communication in a side link, that is, wireless communication with the other UEs 100. The radio communicator 110 includes a receiver 111 and a transmitter 112. The receiver 111 performs various types of reception under the control of the controller 120. The receiver 111 includes an antenna, and converts (down-converts) a radio signal received by the antenna into a baseband signal (reception signal) and outputs the converted signal to the controller 120. The transmitter 112 performs various types of transmission under the control of the controller 120. The transmitter 112 includes an antenna, and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 120 may perform each process in the UE 100 in each embodiment to be described below.

### Configuration of Protocol Stack

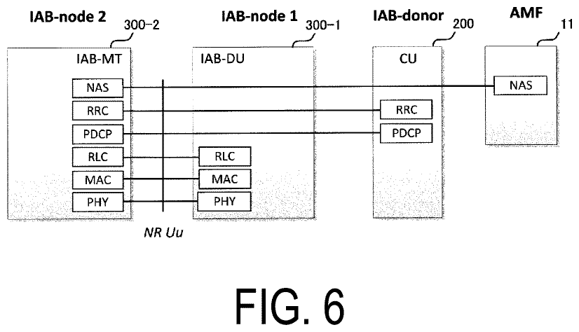

A configuration of a protocol stack according to the embodiment will be described. FIG. 6 is a diagram illustrating an example of a protocol stack relating to RRC connection and NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (a transport block size and a Modulation and Coding Scheme (MCS)) and assigned resource blocks for an uplink and a downlink.

The RLC layer transmits data to the RLC layer on the reception end by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection with the donor node 200 is present, the IAB-MT is in an RRC connected state. When no RRC connection with the donor node 200 is present, the IAB-MT is in an RRC idle state.

The NAS layer that is positioned upper than the RRC layer performs session management, mobility management, and the like. NAS signaling is transmitted between the NAS layer of the IAB-MT of the IAB node 300-2 and the AMF 11.

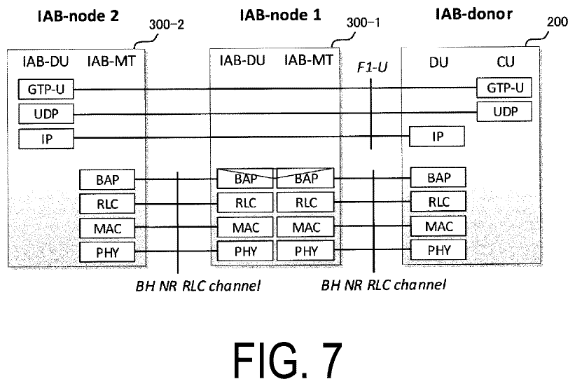

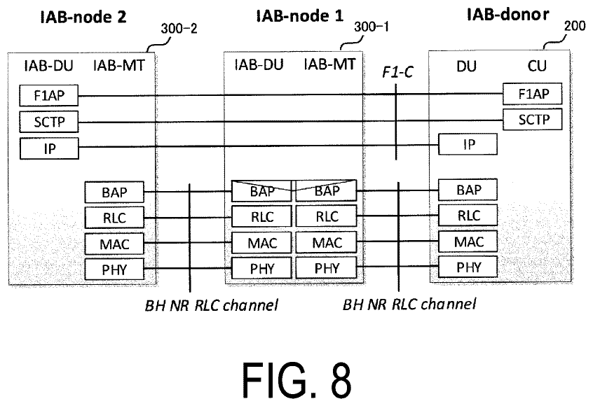

FIG. 7 is a diagram illustrating a protocol stack relating to the F1-U protocol. FIG. 8 is a diagram illustrating a protocol stack relating to the F1-C protocol. Here, an example in which the donor node 200 is divided into a CU and a DU is illustrated.

As illustrated in FIG. 7, the IAB-MT of the IAB node 300-2, the IAB-DU of the IAB node 300-1, the IAB-MT of the IAB node 300-1, and the DU of the donor node 200 each include a Backhaul Adaptation Protocol (BAP) layer as an upper layer of the RLC layer. The BAP layer is a layer for performing a routing process and a bearer mapping/demapping process. In the backhaul, the IP layer is transmitted via the BAP layer, which allows routing by a plurality of hops.

In each backhaul link, a Protocol Data Unit (PDU) of the BAP layer is transmitted by a backhaul RLC channel (BH NR RLC channel). A plurality of backhaul RLC channels is configured in each BH link, thus enabling traffic prioritization and Quality of Service (QOS) control. The PDU of the BAP is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP-U layer and an UDP layer illustrated in FIG. 7.

In the following, processes or operations performed in the IAB-DU and IAB-MT of the IAB may be simply described as processes or operations of the “IAB”. For example, the transmission of a message of the BAP layer to the IAB-MT of the IAB node 300-2 by the IAB-DU of the IAB node 300-1 will be described as the transmission of the message to the IAB node 300-2 by the IAB node 300-1. Processes or operations of the DU or CU of the donor node 200 may also be described simply as processes or operations of the “donor node”.

An upstream direction and an uplink (UL) direction may be used without distinction. A downstream direction and a downlink (DL) direction may be used without distinction.

### Mobile IAB Node

At present, 3GPP has started to study the introduction of a mobile IAB node. The mobile IAB node is, for example, a mobile IAB node. The mobile IAB node may be a movable IAB node. The mobile IAB node may be an IAB node that is capable of moving. The mobile IAB node may be an IAB node that is currently stationary but is certain to move in the future (or is expected to move in the future).

The mobile IAB node allows, for example, the UE 100 under the control of the mobile IAB node to receive services from the mobile IAB node while moving according to the movement of the mobile IAB node. For example, a case is assumed in which a user (or UE 100) who is getting on a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. The intermediate IAB node may be an IAB node that is stationary. The intermediate IAB node may be a stationary IAB node. The intermediate IAB node may be an IAB node that is stationary (or does not move) in a state of being installed at its installation location. The intermediate IAB node may be a stationary IAB node that does not move. The intermediate IAB node may be a fixed IAB node.

The mobile IAB node can also be connected to the intermediate IAB node. The mobile IAB node can also be connected to the donor node 200. The mobile IAB node can also change its connection destination due to its movement (migration or handover). A connection source may be the intermediate IAB node. The connection source may be the donor node 200. The connection destination may be the intermediate IAB node. The connection destination may be the donor node 200.

In the following, the migration of the mobile IAB node and the handover of the mobile IAB node may be used without distinction.

In the following, a mobile IAB node may be a “mobile IAB node”. The mobile IAB node may be a “migrating IAB node”. In either case, the node may be referred to as a mobile IAB node.

### Communication Control Method According to First Embodiment

A communication control method according to the first embodiment will be described.

According to 3GPP, the specification of “iab-Support” (3GPP TS 38.331 V17. 3.0 (2022-12)) has been released as Information Elements (IEs) that can be broadcast with an SIB1. “iab-Support” indicates that a cell having broadcast “iab-Support” supports IAB and is considered as a candidate cell for cell (re) selection in the IAB node. On the other hand, a case where the IE is not included in the SIB1 indicates that the cell having broadcast the SIB1 does not support IAB and/or is a cell barred from the IAB node.

That is, a cell that broadcasts “iab-Support” is a cell that can support the IAB node, and a cell that does not broadcast “iab-Support” is a cell that cannot support the IAB node. Accordingly, the IAB node 300 can access the cell that broadcasts “iab-Support”, and cannot access the cell that does not broadcast “iab-Support” as a barred cell.

On the other hand, 3GPP has agreed on the following items.
(X1) The mobile IAB node may camp on a Rel-16/Rel-17IAB-capable cell. The mobile IAB node may connect to the cell.
(X2) A “supporting mobile-IAB” indication is provided by a Rel-18 mobile IAB capable parent cell.

A cell of the parent node can broadcast that the cell can support a non-movable fixed IAB node (Rel-16/Rel-17IAB) by broadcasting “iab-Support”. The agreed item (X1) enables the mobile IAB node to access (camp on or connect to) the fixed IAB node. That is, the agreed item (X1) enables the mobile IAB node to access the parent node that broadcasts “iab-Support”. “iab-Support” can be considered to indicate that not only a non-movable fixed IAB node can be supported, but also access of a movable mobile IAB node can be supported.

On the other hand, the agreed item (X2) indicates “supporting mobile-IAB”. “supporting mobile-IAB” indicates that, for example, a mobile IAB node can be supported. That is, when the cell of the parent node broadcasts “supporting mobile-IAB”, the mobile IAB node can access the cell.

As described above, the parent node can also broadcast “iab-Support” and can also broadcast “supporting mobile-IAB”.

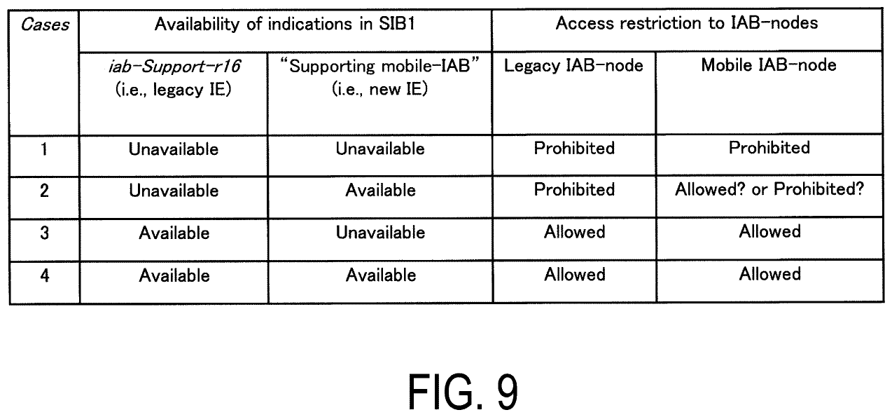

FIG. 9 illustrates a table summarizing whether access restriction is performed, based on the above agreed items. FIG. 9 is a diagram illustrating whether access restriction of an IAB node is performed according to the first embodiment.

Considering that the cell of the parent node can broadcast two pieces of support information (“iab-Support” and “supporting mobile-IAB”), four cases of broadcasting methods exist as illustrated in FIG. 9. Hereinafter, “iab-Support” may be referred to as “legacy IAB node support information”. “supporting mobile-IAB” may be referred to as “mobile IAB node support information”.

In FIG. 9, “Legacy IAB-node” represents a non-movable (fixed) IAB node. Hereinafter, a non-movable IAB node may be referred to as a “legacy IAB node”. The legacy IAB node may be a Rel-16 capable IAB node. The legacy IAB node may be a Rel-17 capable IAB node. In FIG. 9, a “Mobile IAB-node” represents a “mobile IAB node”. The mobile IAB node may be a Rel-18 capable mobile IAB node.

As illustrated in FIG. 9, a “case 1” and a “case 4” are clear.

That is, as illustrated in the “case 1”, a case where the parent node broadcasts neither the legacy IAB node support information nor the mobile IAB node support information indicates that the parent node supports neither the legacy IAB node nor the mobile IAB node. Hence, neither the legacy IAB node nor the mobile IAB node can access the parent node.

As described in the “case 4”, a case where the parent node broadcasts both the legacy IAB node support information and the mobile IAB node support information indicates that the parent node can support both the legacy IAB node and the mobile IAB node. Hence, both the legacy IAB node and the mobile IAB node can access the parent node.

On the other hand, in a “case 3”, when the parent node broadcasts the legacy IAB node support information, a mobile IAB node 300M can access the parent node as described in the above agreed item (X1). That is, the legacy IAB node support information may indicate, for example, that the legacy IAB node is supported and, in addition, that the mobile IAB node is granted to access (camp on or connect to) the cell.

In a “case 2”, since the parent node does not broadcast the legacy IAB node support information, the legacy IAB node is barred from accessing the parent node.

However, in the “case 2”, whether the mobile IAB node can access the parent node is not clear. The mobile IAB node can be considered to unable to access the parent node because the parent node does not broadcast the legacy IAB node support information. The mobile IAB node can be considered to able to access the parent node because the parent node broadcasts the mobile IAB node support information. Hence, there exists a case where the mobile IAB node is not be able to appropriately perform processing on the cell.

In the first embodiment, the mobile IAB node appropriately performs processing on a cell. The “case 2” will be described in the first embodiment.

Note that, in the following description, the meaning of “access” may also include “camp”. “Camp” refers to, for example, a state in which the IAB-MT of the mobile IAB node in an RRC idle state or an RRC inactive state has completed a cell selection procedure or a cell reselection procedure to select a cell used to monitor system information or paging information. In the description, the meaning of “access” may also include “connection”. “Connection” refers to, for example, a state in which the IAB-MT of the mobile IAB node is in an RRC connected state for the cell and can exchange RRC messages with the cell. “Access” may be “camp” and/or “connection”.

In the following description, a “parent node” and “a cell of the parent node” may be used with the same meaning. For example, broadcasting the legacy IAB node support information by the “parent node” and broadcasting the legacy IAB node support information by “the cell of the parent node” may be used with the same meaning (without distinction).

### (1.1) First Operation Example According to First Embodiment

A first operation example according to the first embodiment will be described.

The first operation example according to the first embodiment is processing on the parent node side. That is, this is an example in which the parent node bars the case where the “case 2” occurs.

Specifically, the parent node broadcasts mobile relay node support information (e.g., mobile IAB node support information) indicating that a movable mobile relay node (e.g., mobile IAB node) is supported, and legacy relay node support information (e.g., legacy IAB node support information) indicating both that access of the mobile relay node is granted and that a non-movable legacy relay node (e.g., legacy IAB node) is supported.

As described above, since the parent node broadcasts the legacy IAB node support information and the mobile IAB node support information, the state in which the “case 2” occurs is resolved. Accordingly, the mobile IAB node can appropriately access the parent node and can appropriately perform processing on the cell of the parent node.

The parent node may be the gNB 200. The parent node may be the fixed IAB node 300 that does not move. The parent node may be a node that does not move, and may be a macro cell, a large cell, a small cell, or an indoor cell.

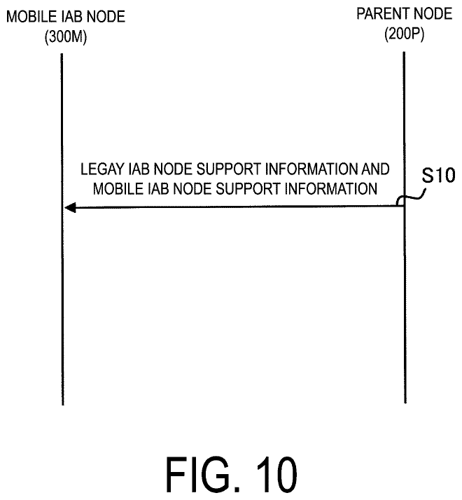

FIG. 10 is a flowchart illustrating the first operation example according to the first embodiment.

As illustrated in FIG. 10, in step S10, a parent node 200P also broadcasts the legacy IAB node support information when broadcasting the mobile IAB node support information. That is, the parent node 200P does not broadcast the mobile IAB node support information to broadcast the legacy IAB node support information, but broadcasts the legacy IAB node support information as a condition for broadcasting the mobile IAB node support information. When not broadcasting the legacy IAB node support information (or the legacy relay node support information), the parent node 200P does not broadcast the mobile IAB node support information (or the mobile relay node support information). Accordingly, the state of the “case 2” is barred. The parent node 200P broadcasts the mobile IAB node support information and the legacy IAB node support information. A configuration of an Information Element (IE) in an SIB may indicate that “the Information Element (IE) of the legacy IAB node support information needs to be set to set the Information Element (IE) of the mobile IAB node support information”. Specifically, an IE configuration may include that, when mobile IAB node support information is set, setting the legacy IAB node support information is a conditional mandatory setting.

The (IAB-MT of the) mobile IAB node 300M receives the two pieces of support information from the parent node 200P. Hence, the mobile IAB node 300M can receive the two pieces of support information and access the cell (“case 4”).

### (1.2) Second Operation Example According to First Embodiment

A second operation example according to the first embodiment will be described.

The second operation example according to the first embodiment is processing on the mobile IAB node 300M side in the “case 2”.

Specifically, first, the parent node (e.g., parent node 200P) broadcasts the mobile relay node support information (e.g., mobile IAB node support information) without broadcasting the legacy relay node support information (e.g., legacy IAB node support information). Second, when not receiving the legacy relay node support information, the mobile relay node (e.g., mobile IAB node 300M) determines that access to the parent node is not possible irrespective of whether the mobile relay node support information is received.

As described above, when not receiving the legacy IAB node support information, the mobile IAB node 300M determines that the access to the parent node having broadcast the legacy IAB node support information is not possible irrespective of whether the mobile IAB node 300M receives the mobile IAB node support information. Hence, the mobile IAB node 300M can appropriately perform processing on the parent node even in the “case 2” state.

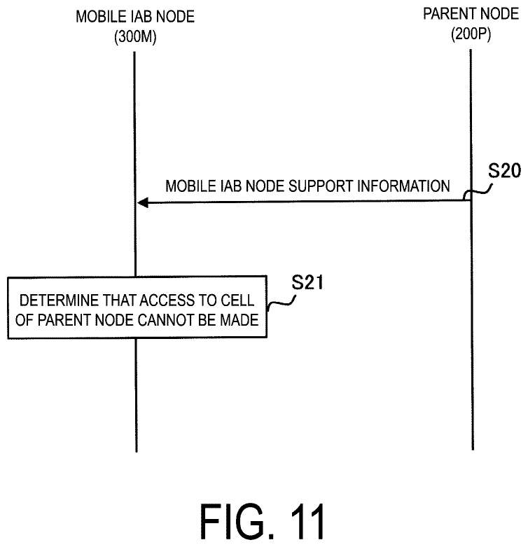

FIG. 11 is a flowchart illustrating the second operation example according to the first embodiment.

As illustrated in FIG. 11, in step S20, the parent node 200P broadcasts the mobile IAB node support information without broadcasting the legacy IAB node support information. The (IAB-MT of the) mobile IAB node 300M receives the mobile IAB node support information without receiving the legacy IAB node support information from the parent node 200P.

In step S21, when not receiving the legacy IAB node support information, (the IAB-MT of) the mobile IAB node 300M determines that access to the parent node 200P cannot be made irrespective of whether the mobile IAB node 300M receives the mobile IAB node support information. In this case, the mobile IAB node 300M may determine that the cell of the parent node 200P is being barred.

The second operation example according to the first embodiment is an operation corresponding to “Prohibited” in the “case 2” in FIG. 9.

### (1.3) Third Operation Example According to First Embodiment

A third operation example according to the first embodiment will be described.

The third operation example according to the first embodiment is also the processing on the mobile IAB node 300M side in the “case 2”.

Specifically, first, the parent node (e.g., parent node 200P) broadcasts the mobile relay node support information (e.g., mobile IAB node support information) without broadcasting the legacy relay node support information (e.g., legacy IAB node support information). Second, when receiving the mobile relay node support information, the mobile relay node (e.g., mobile IAB node 300M) determines that access to the parent node is possible irrespective of whether the mobile relay node receives the legacy relay node support information.

As described above, in the third operation example according to the first embodiment, when receiving the mobile IAB node support information from the parent node 200P, the mobile IAB node 300M determines that access to the cell of the parent node 200P having broadcast the mobile IAB node support information is possible irrespective of whether the mobile IAB node 300M receives the legacy IAB node support information. Hence, the mobile IAB node 300M can appropriately perform processing on the cell even in the state of the “case 2”. This is effective when, for example, the parent node 200P is a base station installed for the mobile IAB node 300M. The base station can operate as a dedicated base station for the mobile IAB node 300M.

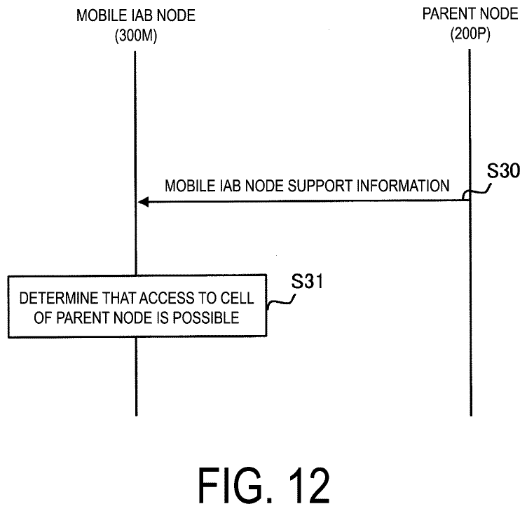

FIG. 12 is a flowchart illustrating the third operation example according to the first embodiment.

As illustrated in FIG. 12, in step S30, the parent node 200P broadcasts the mobile IAB node support information without broadcasting the legacy IAB node support information. The mobile IAB node 300M receives the mobile IAB node support information without receiving the legacy IAB node support information from the parent node 200P.

In step S31, since the mobile IAB node 300M has received the mobile IAB node support information, the mobile IAB node 300M determines that access to the parent node 200P is possible irrespective of whether the mobile IAB node 300M receives the legacy IAB node support information. The mobile IAB node 300M may disregard the absence of the legacy IAB node support information, and determine that access to the parent node 200P is possible in response to reception of the mobile IAB node support information. According to the current specification, the mobile IAB node 300M cannot access cells that do not broadcast the legacy IAB node support information (or the mobile IAB node 300M considers the cells to be barred). However, the mobile IAB node 300M cancels this specification, and determines that access to the parent node 200P is possible.

Note that the legacy IAB node determines that access to the parent node 200P cannot be made (or is considered to being barred).

The third operation example according to the first embodiment is an operation example corresponding to “Allowed” in the “case 2” in FIG. 9.

### Second Embodiment

A second embodiment will be described. In the second embodiment, differences from the first embodiment will be mainly described.

In the first embodiment, the “case 2” in FIG. 9 has been described. The “case 3” in FIG. 9 will be described in the second embodiment. In particular, a condition for the mobile IAB node 300M to access the parent node in the “case 3” will be described in the second embodiment.

### First Operation Example According to Second Embodiment

The first operation example according to the second embodiment is an operation example in which the mobile IAB node 300M accesses the parent node 200P on a condition that connection to the network is granted in the “case 3”.

Specifically, first, the network apparatus (e.g., AMF 11) transmits, to the mobile relay node, connection grant information indicating whether to grant connection to a network that supports the legacy relay node (e.g., legacy IAB node) and does not support the mobile relay node (e.g., mobile IAB node 300M). Second, the parent node (e.g., parent node 200P) broadcasts the legacy relay node support information without broadcasting the mobile relay node support information. Third, the mobile relay node determines that access to the parent node is possible based on the connection grant information when receiving the legacy relay node support information without receiving the mobile relay node support information from the parent node.

As described above, when receiving the legacy IAB node support information without receiving the mobile IAB node support information from the parent node 200P (i.e., “case 3”), the mobile IAB node 300M determines whether access to the parent node 200P is possible based on the connection grant information. Therefore, the condition for accessing the parent node 200P becomes clear in the state of the “case 3”, and the mobile IAB node 300M can appropriately perform processing on the cell.

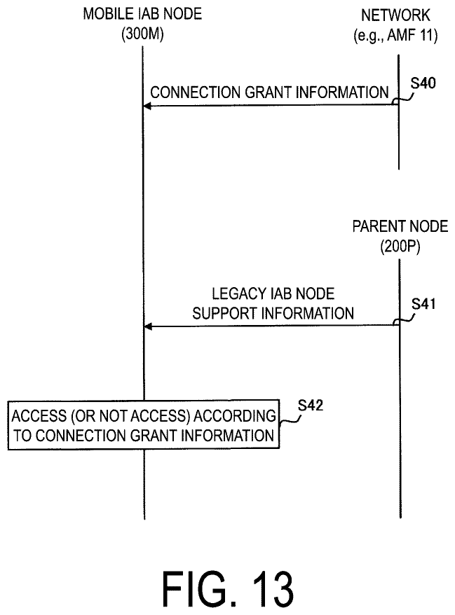

FIG. 13 is a flowchart illustrating the first operation example according to the second embodiment. Hereinafter, the AMF 11 will be described as an example of the network apparatus, but another network apparatus such as an operation management apparatus (or an Operations, Administration and Management (OAM) server) may be used.

As illustrated in FIG. 13, in step S40, the mobile IAB node 300M receives the connection grant information from the AMF 11. The connection grant information is, for example, information indicating whether to grant connection to a network that supports the legacy IAB node and does not support the mobile IAB node 300M. The mobile IAB node 300M having received the connection grant information can recognize whether the connection to the network is granted. The (IAM-MT of the) mobile IAB node 300M may establish initial connection and receive the connection grant information from the AMF 11 in a registration procedure. At this time, the AMF 11 may perform authentication processing for the mobile IAB node 300M, and the connection grant information may be included in the authentication information transmitted from the AMF 11 to the mobile IAB node 300M. The connection grant information may include information of a cell to which connection is granted. The information of the cell may be a cell identifier or may be a gNB identifier. The information may be information of a cell to which connection is not granted. The mobile IAB node 300M can determine whether connection to each cell that mobile IAB node 300M is currently camping on is possible.

In step S41, the parent node 200P broadcasts the legacy IAB node support information without broadcasting the mobile IAB node support information. The (IAB-MT of the) mobile IAB node 300M receives the legacy IAB node support information without receiving the mobile IAB node support information from the parent node 200P.

In step S42, the (IAB-MT of the) mobile IAB node 300M determines whether access to the parent node 200P is possible according to the connection grant information. Specifically, the following operation is performed.

First, when connection to the network is granted by the connection grant information, the mobile IAB node 300M determines that access to the parent node 200P that broadcasts the legacy IAB node support information without broadcasting the mobile IAB node support information is possible. That is, in the “case 3”, if connection to the network is granted by the connection grant information, the mobile IAB node 300M determines that access to the parent node 200P is possible. When, for example, the mobile IAB node 300M cannot find a cell that broadcasts the mobile IAB node support information, the mobile IAB node 300M can determine that access to a cell that broadcasts the legacy IAB node support information is possible on a condition that connection to the network is granted. Note that, if connection to the network is granted, the mobile IAB node 300M may determine that access to another parent node that broadcasts the mobile IAB node support information and the legacy IAB node support information is also possible (“case 4”). That is, the mobile IAB node 300M determines that access to at least the parent node that broadcasts the legacy IAB node support information is possible.

Second, when connection to the network is not granted by the connection grant information, the mobile IAB node 300M determines that access to the parent node 200P is not possible. That is, in the “case 3”, if connection to the network is not granted by the connection grant information, even when the parent node 200P broadcasts the legacy IAB node support information, the mobile IAB node 300M determines that access to the parent node 200P is not possible. In this case, the mobile IAB node 300M determines that access to another parent node (“case 2”) that broadcasts the mobile IAB node support information is possible. The mobile IAB node 300M may determine that a parent node that does not broadcast the mobile IAB node support information is being barred.

### Second Operation Example According to Second Embodiment

A second operation example according to the second embodiment will be described.

The second operation example according to the second embodiment is an operation example in which the mobile IAB node 300M accesses the parent node 200P according to a movement state of the mobile IAB node 300M in the “case 3”.

Specifically, a parent node (e.g., parent node 200P) broadcasts the legacy relay node support information (e.g., legacy IAB node support information) without broadcasting the mobile relay node support information (e.g., mobile IAB node support information). Second, the mobile relay node (e.g., mobile IAB node 300M) determines whether access to the parent node is possible according to the movement state of the mobile relay node.

Thus, for example, the mobile IAB node 300M can determine whether access to the parent node 200P that broadcasts the legacy IAB node support information without broadcasting the mobile IAB node support information is possible according to the movement state of the mobile IAB node 300M, so that the condition for accessing the parent node 200P becomes clear and the mobile IAB node 300M can appropriately perform processing on the cell.

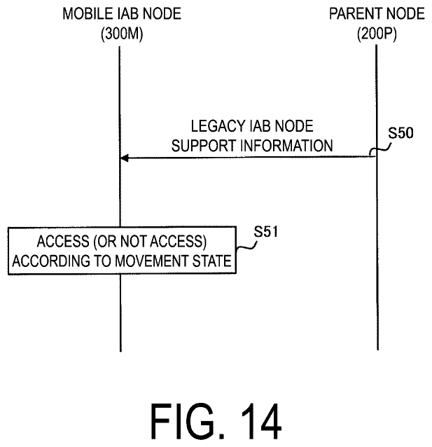

FIG. 14 is a flowchart illustrating the second operation example according to the second embodiment. In the second operation example according to the second embodiment, a speed state of the mobile IAB node 300M (e.g., a low-speed movement state (or a stationary state) or a high-speed movement state) will be described as an example of the movement state.

As illustrated in FIG. 14, in step S50, the parent node 200P broadcasts the legacy IAB node support information without broadcasting the mobile IAB node support information. This is the state of the “case 3”. The (IAB-MT of the) mobile IAB node 300M receives the legacy IAB node support information without receiving the mobile IAB node support information from the parent node 200P.

In step S51, the mobile IAB node 300M determines whether access to the parent node 200P is possible according to the movement state of the mobile IAB node 300M. Specifically, this is as follows.

First, when the mobile IAB node 300M is in the low-speed movement state (or the stationary state), the mobile IAB node 300M determines that access to the parent node 200P that broadcasts the legacy IAB node support information without broadcasting the mobile IAB node support information is possible. This is because, in the “case 3”, when the mobile IAB node 300M is moving at a low speed, the mobile IAB node 300M can determine that the parent node 200P that can support not the mobile IAB node 300M, but the legacy IAB node can also accommodate the mobile IAB node 300M. Note that, for the determination on the low-speed movement state (or the stationary state), the mobile IAB node 300M may measure the movement speed of the mobile IAB node 300M based on a sensor (such as a speed sensor) of the mobile IAB node 300M, a GNSS reception signal, or the like, and determine that the mobile IAB node 300M is in the low-speed movement state (or the stationary state) when the movement speed is equal to or less than a speed threshold value. The speed threshold value may be configured (or broadcast) in advance from the gNB 200. The speed threshold value may be configured from the AMF 11. When the mobile IAB node 300M is in the low-speed movement state (or the stationary state), the mobile IAB node 300M may determine that access to another parent node that broadcasts the mobile IAB node support information and the legacy IAB node support information is also possible (“case 4”). That is, when the mobile IAB node 300M is in the low-speed movement state (or the stationary state), the mobile IAB node 300M determines that access to at least the parent node that broadcasts the legacy IAB node support information is possible.

Second, when the mobile IAB node 300M is in the high-speed movement speed, the mobile IAB node 300M determines that access to the parent node 200P that broadcasts the legacy IAB node support information without broadcasting the mobile IAB node support information is not possible. That is, in the “case 3”, when the mobile IAB node 300M is in the high-speed movement state, and even when the parent node 200P broadcasts the legacy IAB node support information, the mobile IAB node 300M determines that access to the parent node 200P is not possible. This is because, in the “case 3”, when the mobile IAB node 300M is moving at a high speed, the mobile IAB node 300M can determine that the parent node 200P that can support not the mobile IAB node 300M, but the legacy IAB node cannot accommodate the mobile IAB node 300M. For determination on the high-speed movement state, the mobile IAB node 300M may measure a movement speed of the mobile IAB node 300M based on the sensor (such as the speed sensor or the like) of the mobile IAB node 300M, a GNSS reception signal, or the like, and determine that the mobile IAB node 300M is in the high-speed movement state when the movement speed is greater than a speed threshold value. Note that, when the mobile IAB node 300M is in the high-speed movement state, the mobile IAB node 300M determines that access to another parent node (“case 2”) that broadcasts the mobile IAB node support information is possible. When the mobile IAB node 300M is in the high-speed movement state, the mobile IAB node 300M may determine that the parent node that does not broadcast the mobile IAB node support information is being barred.

### Third Operation Example According to Second Embodiment

The speed state of the mobile IAB node 300M has been described as the example of the movement state in the second operation example of the second embodiment. However, the movement state is not limited thereto. Movement range information of the mobile IAB node 300M may be used as the movement state. The movement range information is information indicating a movement range of the mobile IAB node 300M. The movement range information is, for example, information configured in advance for the mobile IAB node 300M from a network apparatus such as the operation management apparatus (or OAM server).

That is, the third operation example according to the second embodiment is an example in which the mobile IAB node 300M determines whether access to the parent node 200P is possible based on the movement range information in the “case 3”.

Specifically, first, the operation management apparatus configures the movement range information indicating the movement range for the mobile relay node (e.g., mobile IAB node 300M). Second, the mobile relay node determines that access to the parent node (e.g., parent node 200P) is possible when the movement range of the mobile relay node is a range threshold value or less, and determines that access to the parent node is not possible when the movement range of the mobile relay node is wider than the range threshold value.

As described above, also in the third operation example according to the second embodiment, the mobile IAB node 300M can determine whether access to the parent node 200P is possible based on the movement range information, so that a condition on whether access is possible becomes clear and the mobile IAB node 300M can appropriately perform processing on the cell.

FIG. 14 is also used for the third operation example according to the second embodiment similarly to the second operation example according to the second embodiment. In this case, by reading the “low-speed movement state (or the stationary state)” as a “narrow-range movement” and reading the “high-speed movement state” as “wide-range movement”, the third operation example according to the second embodiment can be also implemented similarly to the second operation example according to the second embodiment.

Note that the “narrow range” represents, for example, a range in one or more cells managed by the same donor node (CU). A case where the mobile IAB node 300M moves within the cell is “narrow range movement”. On the other hand, for example, the “wide range” has no above limitation, for example, and represents a range including a cell managed by another donor node (CU). A case where the mobile IAB node 300M moves in the range including the cell is “wide range movement”.

A specific example is as follows. That is, the movement range information is configured for the mobile IAB node 300M by the operation management apparatus. The range threshold value is configured (or broadcast) in advance for the mobile IAB node 300M by the gNB 200. Accordingly, the mobile IAB node 300M can determine movement as the “narrow-range movement” when the movement range information is the range threshold value. In this case, the mobile IAB node 300M determines that access to the parent node 200P that broadcasts the legacy IAB node support information without broadcasting the mobile IAB node support information is possible. This is because the mobile IAB node 300M of the narrow range movement can determine that even the parent node 200P can support the mobile IAB node 300M. On the other hand, the mobile IAB node 300M can determine movement as the “wide range movement” when the movement range information is wider than the range threshold value. In this case, the mobile IAB node 300M determines that access to the parent node 200P that broadcasts the legacy IAB node support information without broadcasting the mobile IAB node support information is not possible. This is because the mobile IAB node 300M of the wide range movement can determine that the parent node 200P cannot accommodate the mobile IAB node 300M, the parent node 200P being capable of supporting the legacy IAB node, but not the mobile IAB node 300M.

### OTHER EMBODIMENTS

In the first embodiment and the second embodiment, the examples in which the mobile IAB node 300M determines whether access to the parent node 200P is possible based on whether the mobile IAB node 300M receives the mobile IAB node support information and the legacy IAB node support information have been described.

That is, the mobile relay node (e.g., mobile IAB node 300M) determines whether access to the parent node (e.g., parent node 200P) having broadcast the mobile relay node support information and/or the legacy relay node support information is possible, based on whether the mobile relay node receives the mobile relay node support information (e.g., mobile IAB node support information) indicating that a movable mobile relay node is supported, and the legacy relay node support information (e.g., legacy IAB node support information) indicating both that the mobile relay node is supported and that a non-movable legacy relay node (e.g., legacy IAB node) is supported.

Thus, for example, the mobile IAB node 300M can determine whether the access to the parent node is possible based on whether the mobile IAB node 300M receives the mobile IAB node support information and the legacy IAB node support information, and consequently can appropriately perform processing on a cell of the parent node.

The operation flows described above can be not only separately and independently implemented, but also implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the core network apparatus and at least a part of the base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, System on a chip (SoC)).

The functions implemented by the UE 100 or the gNB 200 (network node) may be implemented in a circuitry or a processing circuitry including a general-purpose processor, a special-purpose processor, an integrated circuit, Application Specific Integrated Circuits (ASIC), a Central Processing Unit (CPU), a conventional circuit, and/or combinations thereof programmed to implement the described functions. The processor includes transistors and other circuits, and is regarded as a circuitry or a processing circuitry. The processor may be a programmed processor that executes a program stored in a memory. As used herein, a circuitry, units, and means are hardware that is programmed to implement or executes the described functions. The hardware may be any hardware disclosed herein or any hardware programmed to implement or known to execute the described functions. When the hardware is a processor that is regarded as a type of a circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on.” Similarly, the phrase “depending on/in response to” means both “only depending on/in response to” and “at least partially depending on/in response to.” The terms “include,” “comprise” and variations thereof do not mean “include only items stated” but instead mean “may include only items stated” or “may include not only the items stated but also other items.” The term “or” used in the present disclosure is not intended to be “exclusive or.” Any references to elements using designations such as “first” and “second” as used in the present disclosure do not generally limit the quantity or the order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### FIRST SUPPLEMENTARY NOTES

### Supplementary Note 1

A communication control method used in a cellular communication system includes, at a parent node, when broadcasting mobile relay node support information, broadcasting legacy relay node support information, the mobile relay node support information indicating that a mobile relay node that is movable is supported, and the legacy relay node support information indicating that access of the mobile relay node is granted and a legacy relay node that is not movable is supported.

### Supplementary Note 2

According to the communication control method described in Supplementary Note 1, the broadcasting includes, at the parent node, not broadcasting the mobile relay node support information when not broadcasting the legacy relay node support information.

### Supplementary Note 3

A communication control method used in a cellular communication system includes, at a mobile relay node, determining whether access to a parent node having broadcast mobile relay node support information and/or legacy relay node support information is possible, based on whether the mobile relation node receives the mobile relay node support information indicating that the mobile relay node that is movable is supported, and the legacy relay node support information indicating that access of the mobile relay node is granted and a legacy relay node that is not movable is supported.

### Supplementary Note 4

The communication control method described in any one of Supplementary Note 1 to Supplementary Note 3 further includes, at the parent node, broadcasting the mobile relay node support information without broadcasting the legacy relay node support information, and the determining includes, at the mobile relay node, determining that the access to the parent node is not possible irrespective of whether the mobile relay node receives the mobile relay node support information if the mobile relay node does not receive the legacy relay node support information.

### Supplementary Note 5

The communication control method described in any one of Supplementary Note 1 to Supplementary Note 4 further includes, at the parent node, broadcasting the mobile relay node support information without broadcasting the legacy relay node support information, and the determining includes, at the mobile relay node, determining that the access to the parent node is possible irrespective of whether the mobile relay node receives the legacy relay node support information if the mobile relay node receives the mobile relay node support information.

### Supplementary Note 6

The communication control method described in any one of Supplementary Note 1 to Supplementary Note 5 further includes at a network apparatus, transmitting connection grant information to the mobile relay node, the connection grant information indicating whether to grant connection to a network configured to support the legacy relay node and not support the mobile relay node; and at the parent node, broadcasting the legacy relay node support information without broadcasting the mobile relay node support information, and the determining includes, at the mobile relay node, determining whether the access to the parent node is possible according to the connection grant information when receiving the legacy relay node support information without receiving the mobile relay node support information from the parent node.

### Supplementary Note 7

According to the communication control method described in any one of Supplementary Note 1 to Supplementary Note 6, the determining includes, at the mobile relay node, determining that the access to the parent node is possible when the connection grant information indicates that connection to the network is granted, and that the access to the parent node is not possible when the connection grant information indicates that the connection to the network is not granted.

### Supplementary Note 8

The communication control method described in any one of Supplementary Note 1 to Supplementary Note 7 further includes, at the parent node, broadcasting the legacy relay node support information without broadcasting the mobile relay node support information, and the determining includes, at the mobile relay node, determining whether the access to the parent node is possible according to a movement state of the mobile relay node.

### Supplementary Note 9

According to the communication control method described in any one of Supplementary Note 1 to Supplementary Note 8, the determining includes, at the mobile relay node, determining that the access to the parent node is possible when a movement speed of the mobile relay node is equal to or less than a speed threshold value, and that the access to the parent node is not possible when the movement speed of the mobile relay node is greater than the speed threshold value.

### Supplementary Note 10

The communication control method described in any one of Supplementary Note 1 to Supplementary Note 9 further includes, at an operation management apparatus, configuring movement range information indicating a movement range for the mobile relay node, and the determining includes, at the mobile relay node, determining that the access to the parent node is possible when the movement range of the mobile relay node is equal to or less than a range threshold value, and that the access to the parent node is not possible when the movement range of the mobile relay node is a range wider than the range threshold value.

### SECOND SUPPLEMENTARY NOTES

### 1. Introduction

The WID relating to a mobile IAB was revised in the RAN #97e with the following objectives. The detailed objectives of WI are as follows.
To define migration/topology adaptation procedures to achieve IAB node mobility, including inter-donor migration of an entire mobile IAB node (full migration) [RAN3 and RAN2].
   The mobile IAB node can connect to a stationary (intermediate) IAB node. Optimization specific to a scenario where a mobile IAB node is connected to a stationary (intermediate) IAB node or is directly connected to an IAB donor DU is not prioritized.
   Mobility of a dual-connected IAB node is prioritized down.
   Mobility of the IAB node and the UE thereof is enhanced, including aspects relating to group mobility. There is no optimization for targeting at surrounding UEs [RAN3 and RAN2].

Note: Solutions need to avoid touching on topics already discussed in Rel-17 or topics excluded from Rel-17, but IAB node mobility-specific enhancements are exceptional.

Mitigation of interference due to IAB node mobility, including avoidance of a potential collision between a reference signal and a control signal (PCI, RACH, and the like) [RAN3, RAN2].

The following principles need to be respected:

The mobile IAB node needs to be able to provide a service to a legacy UE.
Solutions providing optimization for the mobile IAB may involve enhancements to the Rel-18 UE.

In these appendices, details of mobility enhancement for a mobile IAB are described.

### 2. Discussion

### 2.1 Enhancement of UE Mobility

### 2.1.1 Enhancement of Cell Reselection Function of UE

The RAN2 #119bis-e has agreed on the following confirmations, observations, and assumptions.
The RAN2 confirms that a mobile IAB needs to be associated with a legacy UE.
The RAN2 has confirmed that, when camping on/connecting to a mobile IAB cell for an extended period of time, the UE may consider itself to be on board the mobile IAB cell (in other words, the UE needs to know that the cell is such a cell). The time needs to be further studied.

The RAN2 makes a following assumption on the UE that operates in the mobile IAB cell.
Assumption 1: From a viewpoint of a NW of the mobile IAB cell, the principle of configuring legacy parameters (including cell (re) selection, cell reservation, and access restriction) is not different from that of a legacy IAB cell.
Assumption 2: There is no specification impact on the operations of legacy UEs.
Assumption 3: The information of the mobile IAB cell newly broadcast by the R18 (if agreed) does not bar/control access from legacy UEs.
Assumption 4: Non-enhancement-capable UEs (including legacy UEs and non-enhancement-capable R18 UEs) only ignore the information of the mobile IAB cell newly broadcast by the R18 (if agreed).

### RAN2 Assumption: Mobile IAB Cell Broadcast Information

To assist mobility in an idle/inactive mode of the Rel-18 UE, a 1-bit mobile IAB cell type indication is introduced (further studies are needed when the UE needs to know that the UE is on board the mobile IAB cell).
How this is used may vary depending on implementation.
From a viewpoint of mobile IAB WI, the RAN2 does not specify modifications for suppressing surrounding UEs from accessing the mobile IAB node. However, the RAN2 considers that the SA2 may be working on applicable Rel-18 solutions (the RAN2 waits for the SA2).

The RAN2 #120 has further agreed upon the following assumptions.

For the assumed mobile IAB cell type indication, it is assumed that the RAN2 may be defined if any related UE operation is defined.

Based on the agreement, cell reselection of the UE is analyzed from viewpoints of mobility scenarios, expected UE operations, and deployment scenarios.

### 2.1.1.1. Mobility Scenario and Expected UE Operation

Two main scenarios and some subcases involving expected operations of the UE can be considered as follows.
Scenario A: The mobile IAB node is migrating together with a camping UE.
Subcase A1: A UE (e.g., inside a train or the like) needs to stay on the mobile IAB node.
Subcase A2: Surrounding UEs (e.g., outside the train or the like) need not to camp on the mobile IAB node.
Scenario B: The mobile IAB node is at a stop together with the camping UE.
Subcase B1: The UE (e.g., still on the train) needs to stay on the mobile IAB node.
Subcase B2: The UE (e.g., getting off the train) needs to reselect a stationary cell (e.g., a macro cell).
Subcase B3: The surrounding UEs (e.g., getting on the train) need to reselect the mobile IAB node.
Subcase B4: Surrounding UEs (e.g., still at a station) need to stay on their fixed cells.
   In the subcases A1, B1, and B2, the UE is installed near the mobile IAB node. The sub-case A1 in particular is the main case that the WID has clearly identified as follows.

Mobility of the IAB node and the UE thereof is enhanced, including aspects related to group mobility. There is no optimization for targeting at surrounding UEs [RAN3 and RAN2]. Note: Solutions need to avoid touching on topics already discussed in Rel-17 or topics excluded from Rel-17, but IAB node mobility-specific enhancements are exceptional.

In the subcases A2, B3, and B4, these operations are operations desirable for the surrounding UEs. The WID specifies that no optimization for targeting at the surrounding UEs is performed. For the subcase B3, the UE enters the subcase B1 or B2 after getting on the train, but the initial state of the UE remains in the state of the surrounding UE. Therefore, these subcases are uncovered by the Rel-18.

Mobility of the IAB node and the UE thereof is enhanced, including aspects related to group mobility. There is no optimization for targeting at surrounding UEs [RAN3 and RAN2].

Only the subcases A1, B1 and B2 will be considered below.

Observation 1: Optimization for targeting at surrounding UEs is outside the range of WI, but the same configuration as those in Observation 2 and Observation 4 may be applicable.

### 2.1.1.2. Inter-Frequency Deployment

This deployment scenario assumes that the mobile IAB node is deployed at a frequency different from a frequency for the macrocell (i.e., external cell).

In the subcase A1, the UE migrates together with the mobile IAB node. For this reason, RSRP and RSRQ from the mobile IAB node are always stable and sufficiently good. For example, a mobile IAB node broadcasts the frequency priority of the mobile IAB node as “7” or broadcasts the cell of the mobile IAB node as an HSDN cell (i.e., the UE regards this frequency as the most prioritized frequency).

A train includes a plurality of vehicles and a mobile IAB node is considered to be deployed in each vehicle. Even when the UE moves between the vehicles, one of the cells of the mobile IAB node is always more stable than an external macro cell viewed from the UE in the train. As a typical case, it is assumed that the mobile IAB node cells operate on the same frequency. In this case, the existing intra-frequency cell reselection, that is, the R-criterion, functions appropriately.

Observation 2: A general configuration may include that the migrating mobile IAB cell broadcasts a priority of a serving frequency as “7” or broadcasts the HSDN cell indication to suppress cell reselection of the UE migrating with the mobile IAB cell.

In the subcases B1 and B2, no way exists for the AS to know whether the user will stay on the train or leave the train. In this case, even when a mobile IAB node broadcasts some information, the UE cannot determine which cell (the mobile IAB node or the fixed macro cell) needs to be reselected finally. For this reason, which cell the UE needs to reselect finally depends on a radio condition and a frequency priority. That is, the mobile IAB node broadcasts the priority of the serving frequency in, for example the same way as that of the fixed macro cell layer, or stops broadcasting the HSDN cell indication.

Observation 3: When the UE and the mobile IAB node stop, the UE cannot determine whether to reselect the mobile IAB node unless the UE recognizes the intention of the user. For this reason, which cell the UE needs to reselect depends on the radio condition.

Observation 4: As in a typical configuration, the mobile IAB cell in the stationary state recovers the frequency priority or the HSDN cell indication used at a time of migration (in other words, this is similar to Observation 2).

However, in light of the above-described observation results, a drawback of the current mechanism is that the SIB of the mobile IAB node needs to be changed according to the movement state (Observation 2 applies during migration, and Observation 4 applies during stop). However, this problem may not be a serious problem that needs to be solved.

Observation 5: A drawback of the current mechanism is that the mobile IAB cell needs to change the SIB according to the movement speed.

In summary, in a case of inter-frequency deployment, the existing cell reselection mechanism, that is, a cell reselection mechanism based on a radio condition and a frequency priority, still functions well. For this reason, no enhancement is required for the UE to execute cell reselection.

The HSDN is valid for the subcase A1.

Proposal 1: If the mobile IAB node and the macro cell are deployed on different frequencies, the RAN2 needs to agree that no enhancement is needed for cell reselection of the UE, that is, the RAN2's assumption of a “1-bit mobile IAB cell type indication” is unnecessary.

### 2.1.1.3. Intra-Frequency Deployment

This deployment scenario assumes that the mobile IAB node is deployed on the same frequency as that of the macrocell (i.e., the mobile IAB node is a foreign cell).

For intra-frequency (and inter-frequency with equal priority) cell reselection, the UE needs to follow a ranking mechanism (i.e., R-criterion), and the range of q-OffsetCell in SIB3 is −24 dB to +24d11llB.

TABLE 1
Rs = Qmeas, ₛ + Q_{hyst} − Qoffsetₜₑₘₚ
Rn = Qmeas, ₙ − Qoffset − Qoffsetₜₑₘₚ

| Qₘₑₐₛ | RSRP Measurement Amount Used for Cell Reselection |
|---|---|
| Qoffset | Intra-frequency: when Qoffset_{s, n} is valid, equal to Qoffset_{s, n}, and |
| | otherwise equal to zero. |
| | Inter-frequency: when Qoffset_{s, n} is valid, equal to a value obtained by |
| | adding Qoffset_{frequency} to Qoffset_{s, n}, and otherwise equal to |
| | Qoffset_{frequency}. |
| Qoffsetₜₑₘₚ | The offset temporarily applied to the cell as defined in TS 38.331 |

In the subcase A1, the migrating mobile IAB cell may broadcast Qoffset for the macrocell as a large positive value, and Qoffset for the other mobile IAB cells as zero. In this configuration, a UE migrating with an IAB cell prioritizes the mobile IAB cell over the macro cell.

Observation 6: A general configuration may include that the migrating IAB cell broadcasts Qoffset of the macrocell as a large positive value.

As for the subcases B1 and B2, since cell reselection depends on the radio condition as explained in above Observation 3, the mobile IAB cell needs to reset a Qoffset value used during migration to an original value.

Observation 7: The general configuration may include that the migrating IAB cell resets the Qoffset value used during migration to the original value (in other words, this is similar to Observation 6).

One of the drawbacks is that the SIB is frequently changed according to a movement status of the IAB node similarly to Observation 5 above.

Observation 8: A drawback of the current mechanism is that the mobile IAB cell needs to change the SIB according to the movement state.

In summary, in a case of intra-frequency deployment, the existing cell reselection mechanism, i.e. cell reselection based on prioritization in the radio state, still works well. For this reason, no enhancement is required for the UE to execute cell reselection.

Proposal 2: If the mobile IAB node and the macro cell are installed on the same frequency, the RAN2 needs to agree that no enhancement is needed for cell reselection of the UE, that is, the “1-bit mobile IAB cell type indication” is unnecessary as assumed by the RAN2.

### 2.1.2. RACH-Less Handover of Rel-18 UE

The RAN2 #119e has reached the following agreement.
The R2 assumes that it is assumed that an RACH-less procedure may be considered for an on-board RRC connected UE to be handed over with the mobile IAB node (this also depends on the assumption of UL synchronization).

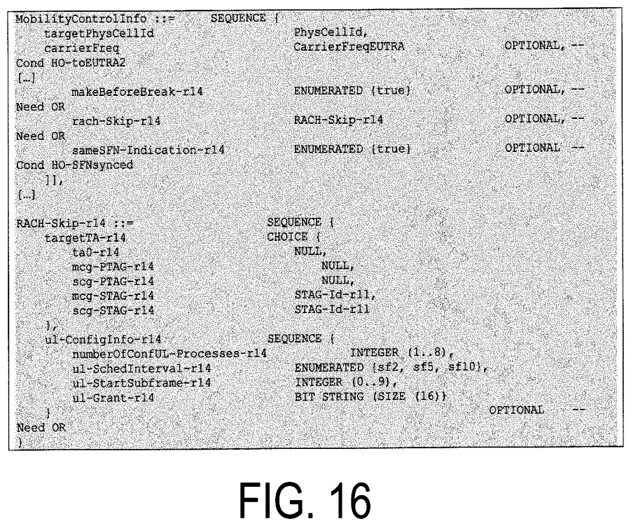

In the LTE, an RACH-less handover is configured as illustrated in FIG. 16 by using applicable Timing Advance (TA) and uplink grant information in MobilityControlInfo.

Regarding a TA value for the UE in an RACH-less handover during an IAB node migration, a source cell and a target cell are provided via the same “physical” DU (but dual “logical” DU), and thus the UE is considered to apply the latest TA value in order to access the target cell. That is, a “physical” distance from the UE needs to be the same. Thus, the UE does not need to configure an explicit TA value. On the other hand, when an RACH-less handover is used for other scenarios, for example, a mobile IAB-MT handover, a generic approach like the LTE configuration is required.

Proposal 3: The RAN2 needs to discuss whether the UE implicitly applies the latest TA value or explicitly configures the corresponding TA value for the RACH-less handover of the UE.

The UE needs to transmit RRC Reconfiguration Complete in UL resources given by the target cell, and thus UL grant information needs to be configured for the UE.

Proposal 4: The RAN2 needs to agree for the RACH-less handover of the UE that UL grant information is configured by a target IAB donor CU.

Considering an RRC IE structure of NR, an RACH-less configuration can be assumed to be included in reconfigurationWithSync in CellGroupConfig because the RACH-less handover is indicated by the target IAB donor CU during a handover procedure.

Proposal 5: The RAN2 needs to agree that the RACH-less handover is configured with a handover command, that is, a reconfiguration with synchronization.

One question is whether the RACH-less handover is also applicable to a conditional handover. The RAN2 #119e agreed that it would be useful to support a conditional RACH-less handover because “R2 assumes that a CHO or a delayed RRC configuration can be the baseline for group mobility”.

Proposal 6: The RAN2 needs to discuss whether an RACH-less handover can be also configured by a conditional handover, that is, the conditional reconfiguration.

### 2.2. Enhancement of IAB-MT Mobility

### 2.2.1. Access Restriction

### 2.2.1.1. Access of Stationary IAB Node

In the WID, mobile IAB nodes provide services only to UEs. This means that the mobile IAB node does not need to provide services to other IAB nodes as a child node. The mobile IAB does not have descendant IAB nodes and provides services only to UEs.

To achieve requirements, the RAN2 #119e has agreed as follows.

A method of not broadcasting the iab-Support indication is sufficient to suppress other IAB nodes from accessing the mobile IAB (without a further influence on the specifications).

However, the agreement is not considered to have been reached upon full discussion. Whether it is really sufficient to leave the part “(without the further influence on the specification)” in particular to the implementation is questionable. Since the WID clearly requires that a mobile IAB node cannot access other mobile IAB nodes, the clarification of this premise in the specification is considered to be necessary in order to avoid confusion in mobile IAB implementations. For this reason, the Stage-2 specifications desirably incorporate the above agreement or clarify that “the mobile IAB node cannot access other mobile IAB nodes in this release”.

Proposal 7: The RAN2 needs to agree to incorporate, in the Stage-2 specifications, not configuring an IAB support IE (Information Element) in an SIB when an IAB node operates as a mobile IAB node in this release.

### 2.2.1.2. Access of Mobile IAB Node

The RAN2 #120 has achieved the following agreement for the mobile IAB node to access the parent node.
The mobile IAB node can camp on and connect to a legacy Rel-16/Rel 17IAB-capable cell.
The R2 assumes that a “supporting mobile-IAB” indication is provided from a Rel-18 mobile IAB-capable parent cell.

Based on the agreement, the correspondence between an indicated availability and a behavior of the IAB node is summarized.

TABLE 2
SIB Indication and Operation of IAB node

| | Adapted or Not Adapted to SIB1 | | | |
|---|---|---|---|---|
| | iab-Support- | “Support of | Access Restriction to IAB Node | |
| | r16 | Mobile IAB” | Legacy IAB | Mobile IAB |
| Case | (Legacy IE) | (New IE) | Node | Node |
| 1 | Unusable | Unusable | Barred | Barred |
| 2 | Unusable | Available | Barred | Granted? Or |
| | | | | Barred? |
| 3 | Available | Unusable | Possible | Possible |
| 4 | Available | Available | Possible | Possible |

As for the cases 1 and 4, the operation of the mobile IAB node is clear as shown in Table 2.

Proposal 8: The RAN2 needs to agree that the mobile IAB is barred from accessing a parent that does not broadcast both the legacy IAB support IE and a new “supporting mobile-IAB” IE.

Proposal 9: The RAN2 needs to agree that the mobile IAB evaluates the parent that broadcasts both the legacy IAB support IE and the new “supporting mobile-IAB” IE.

As for the case 2, if the legacy IAB support IE is not provided and a new indication is provided, whether the mobile IAB node can access the parent node is unclear. Furthermore, whether broadcasting only the new indication without the legacy IE from the parent node is a valid case needs to be discussed. A typical case is considered to be that the parent node accepts both accesses of the legacy IAB node and the mobile IAB node. However, the parent node may be also installed only for the mobile IAB node. Hence, it may be good to keep the flexibility of the configuration.

Proposal 10: The RAN2 needs to discuss whether it is a valid configuration that the legacy IAB support IE is not provided while the new “supporting mobile-IAB” IE is broadcast (i.e. in the case in Table 2).

As for the case 3, that is, the case where the legacy IAB support IE is provided, but no new indication is provided, the RAN2 has agreed that “the mobile IAB node can camp on and connect to the legacy Rel-16/Rel-17IAB-capable cell”, so that the mobile IAB node can access the parent. However, the expected operation of the IAB node is the same as that in the case 4. The mobile IAB node can access the parent under a specific condition in the case 3, but is considered to be always able to access the parent in the case 4. For example, the mobile IAB node can only access the parent if the mobile IAB node does not find a cell that broadcasts a new indication. In another example, whether the mobile IAB node is granted to access a cell that does not broadcast a new indication may be configured for the mobile IAB node in an approval/verification process by, for example, the AMF or the OAM. For this reason, the RAN2 needs to clarify under what conditions the mobile IAB node can access a parent cell that does not broadcast a new indication.

Proposal 11: The RAN2 needs to discuss under what condition the mobile IAB node is granted to access a parent node that broadcasts the legacy IAB support IE (the case 3 in Table 2), yet does not provide the new “supporting mobile-IAB” IE. For example, access to the parent node is granted only if no cell that broadcasts a new indication is found.

1. A communication control method used in a cellular communication system, the communication control method comprising:
at a legacy relay node, allowing access a cell when the legacy relay node receives legacy relay node support information indicating support for the legacy relay node from the cell without receiving mobile relay node support information indicating support for a movable mobile relay node from the cell, and barring access to a cell when the legacy relay node does not receive the legacy relay node support information from the cell without receiving the mobile relay node support information from the cell, and
at the mobile relay node, allowing access a cell when the mobile relay node receives the mobile relay node support information from the cell without receiving the legacy relay node support information from the cell, and barring access to the cell when the mobile relay node does not receive the mobile relay node support information from the cell without receiving the legacy relay node support information from the cell.

2. The communication control method according to claim 1, wherein the mobile relay node support information is applied to the mobile relay node.

3. A relay node being not movable in cellular communication system, the relay node comprising transceiver circuitry and processing circuitry operatively associated with the transceiver circuitry and configured to execute processing of:
allowing access a cell when the relay node being not movable receives legacy relay node support information indicating support for the relay node being not movable from the cell without receiving mobile relay node support information indicating support for a movable mobile relay node from the cell, and barring access to a cell when the relay node being not movable does not receive the legacy relay node support information from the cell without receiving the mobile relay node support information from the cell.

4. A relay node being movable in cellular communication system, the relay node comprising transceiver circuitry and processing circuitry operatively associated with the transceiver circuitry and configured to execute processing of:
allowing access a cell when the movable relay node receives mobile relay node support information indicating support for the movable relay node from the cell without receiving legacy relay node support information indicating support for a relay node being not movable from the cell, and barring access to the cell when the mobile relay node does not receive the mobile relay node support information from the cell without receiving the legacy relay node support information from the cell.

5. A cellular communication system comprising the relay node being not movable according to claim 3 and a relay node being movable.

6. A non-transitory computer-readable storage medium storing a program for causing a computer of a cellular communication system to execute processing comprising:
at a legacy relay node, allowing access a cell when the legacy relay node receives legacy relay node support information indicating support for the legacy relay node from the cell without receiving mobile relay node support information indicating support for a movable mobile relay node from the cell, and barring access to a cell when the legacy relay node does not receive the legacy relay node support information from the cell without receiving the mobile relay node support information from the cell, and
at the mobile relay node, allowing access a cell when the mobile relay node receives the mobile relay node support information from the cell without receiving the legacy relay node support information from the cell, and barring access to the cell when the mobile relay node does not receive the mobile relay node support information from the cell without receiving the legacy relay node support information from the cell.

7. A chipset for a cellular communication system, the chipset comprising:
at a legacy relay node, allowing access a cell when the legacy relay node receives legacy relay node support information indicating support for the legacy relay node from the cell without receiving mobile relay node support information indicating support for a movable mobile relay node from the cell, and barring access to a cell when the legacy relay node does not receive the legacy relay node support information from the cell without receiving the mobile relay node support information from the cell, and
at the mobile relay node, allowing access a cell when the mobile relay node receives the mobile relay node support information from the cell without receiving the legacy relay node support information from the cell, and barring access to the cell when the mobile relay node does not receive the mobile relay node support information from the cell without receiving the legacy relay node support information from the cell.
